(19) United States
(12) Patent Application Publication
(10) Pub. No.: US 2004/0086778 A1
(43) Pub. Date: May 6, 2004

(54) Exhaust structure of storage battery

(75) Inventors: Kenji Nakano, Fukushima (JP); Shyuichi Yabuki, Fukushima (JP); Hisashi Ouchi, Fukushima (JP); Ichiro Sano, Kanagawa (JP)

Correspondence Address: MCGINN & GIBB, PLLC, 8321 OLD COURTHOUSE ROAD, SUITE 200, VIENNA, VA, 22182-3817, US

(73) Assignee: The Furukawa Battery Co., Ltd., Yokohama-shi (JP)

(21) Appl. No.: 10/693,490

(22) Filed: Oct. 27, 2003

(30) Foreign Application Priority Data
Oct. 28, 2002 (JP) P2002-312003

(51) Int. Cl. H01M 2/12

(52) U.S. Cl. 429/82; 429/88; 429/89

(57) ABSTRACT

An exhaust structure is provided on an upper part of a storage battery. In the structure, an exhaust chamber is formed with an inlet, through which gas generated from a cell chamber of the storage battery is introduced, a first outlet, arranged in an upper portion of the exhaust chamber and through which the gas is exhausted to an exterior of the storage battery, a second outlet, arranged in a bottom portion of the exhaust chamber and communicated with the cell chamber, side walls and a bottom wall defining the exhaust chamber. The bottom wall is slanted toward the second outlet. A plurality of plate members, which intercepts liquid contained in the gas. Each of the plate members is extended from one of the side walls such that a distal end portion faces another one of the side walls while defining a gap therebetween, and is slanted toward the second outlet so that the intercepted liquid is guided to the second outlet and returned to the cell chamber.

### BACKGROUND OF THE INVENTION

This invention relates to an exhaust structure of a storage battery.

In a storage battery and particularly in a lead storage battery, there are provided exhaust ports for discharging internal gas produced during the charging or discharging of the storage battery. In order to exhaust only the produced gas while preventing a splash (due to the scattering of an electrolyte caused by vibrations during use) and the leakage of liquid drops, an introduction port for introducing the produced gas into an exhaust chamber (formed in an upper portion such as a lid of the storage battery), as well as an exhaust port for exhausting the introduced gas from the exhaust chamber, is provided in each exhaust chamber. Many splash-proof plates are provided within the exhaust chamber to form a labyrinth, and a bottom surface of the exhaust chamber is slanting toward the introduction port. Such a structure is disclosed in Japanese Utility Model Publication No. 54-131037U.

In the above exhaust structure, since the slanting surface is provided only at the bottom surface of the exhaust chamber, although a splash and liquid drops which have entered the exhaust chamber are intercepted by the splash-proof plates and are temporarily prevented from being discharged through an exhaust nozzle, the intercepted liquid is not separated from the surface of each splash-proof plate, and remains on a lower portion of the splash-proof plate.

Because of the vibration of the storage battery or others, this liquid soon intrudes into an adjacent exhaust chamber associated with an adjacent battery cell. As a result, there is an anxiety that such liquid would accidentally leak to an undesired part of the storage battery such as a filter chamber in which an explosion-proof filter or the exterior of the storage battery via the exhaust nozzle.

### SUMMARY OF THE INVENTION

It is therefore an object of the invention to provide an exhaust structure of a storage battery capable of preventing from the above accident being occurred.

In order to achieve the above object, according to the invention, there is provided an exhaust structure provided on an upper part of a storage battery, comprising:

an exhaust chamber, formed with:

an inlet, through which gas generated from a cell chamber of the storage battery is introduced;

a first outlet, arranged in an upper portion of the exhaust chamber and through which the gas is exhausted to an exterior of the storage battery;

a second outlet, arranged in a bottom portion of the exhaust chamber and communicated with the cell chamber; and

side walls and a bottom wall defining the exhaust chamber, the bottom wall being slanted toward the second outlet; and

a plurality of plate members, which intercepts liquid contained in the gas, each of the plate members being extended from one of the side walls such that a distal end portion faces another one of the side walls while defining a gap therebetween, and being slanted toward the second outlet so that the intercepted liquid is guided to the second outlet and returned to the cell chamber.

In this configuration, the intercepted liquid is rapidly returned to the cell chamber without residing in the exhaust chamber. Accordingly, the undesired movement of the intercepted liquid can be prevented.

### BRIEF DESCRIPTION OF THE INVENTION

The above objects and advantages of the present invention will become more apparent by describing in detail preferred exemplary embodiments thereof with reference to the accompanying drawings, wherein:

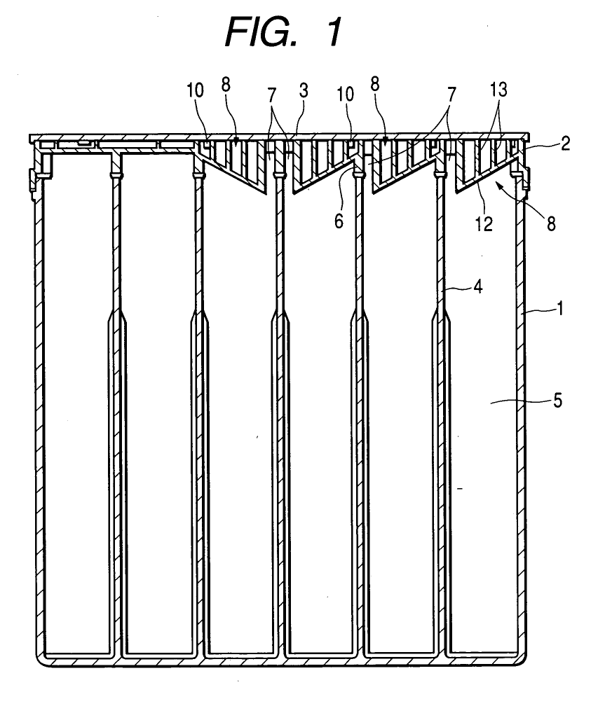

FIG. 1 is a cross-sectional view of a storage battery according to a first embodiment of the invention;

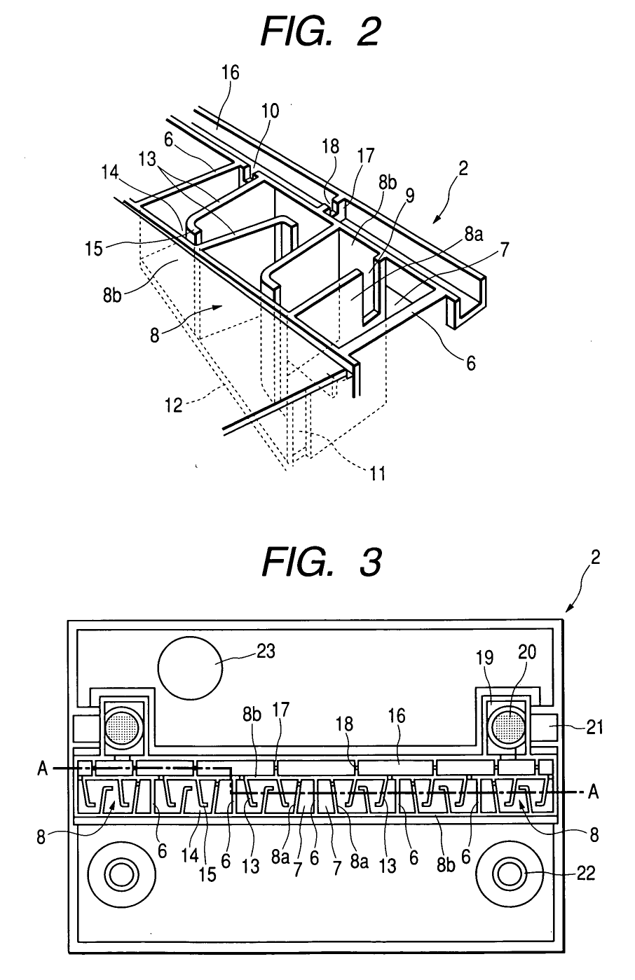

FIG. 2 is an enlarged perspective view showing an exhaust chamber of the storage battery of FIG. 1;

FIG. 3 is a top plan view of a lid of the storage battery of FIG. 1;

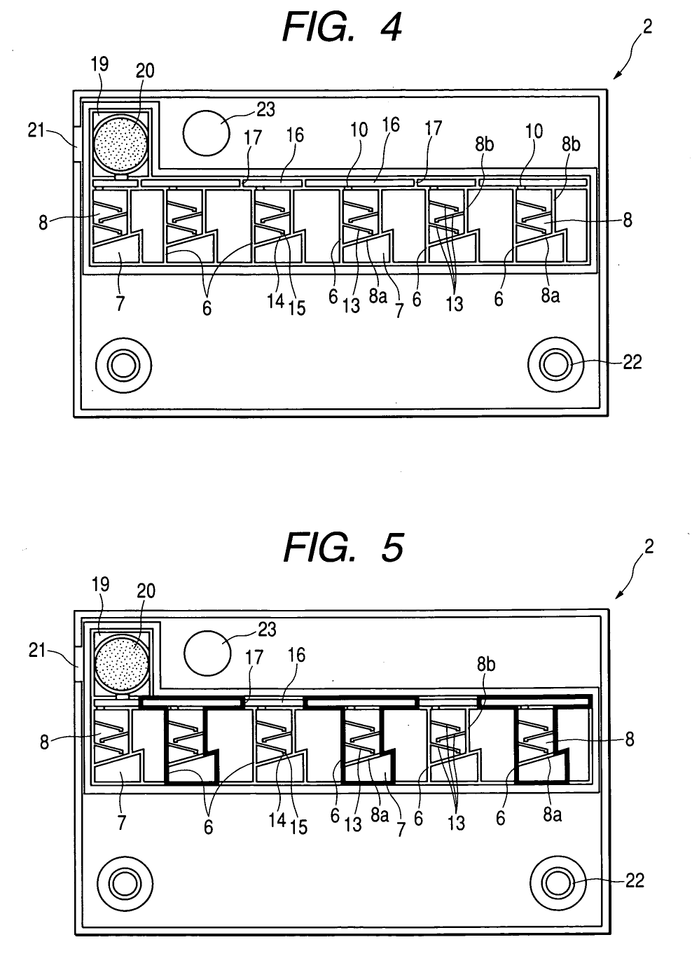

FIG. 4 is a top plan view of a lid of a storage battery according to a second embodiment of the invention; and

FIG. 5 is a top plan view for explaining an airtightness test for the storage battery of FIG. 4.

### DETAILED DESCRIPTION OF THE INVENTION

Preferred embodiments of the invention will be described below with reference to the accompanying drawings.

As shown in FIG. 1, in a storage battery according to a first embodiment of the invention, the interior of a battery case 1 is divided into six cell chambers 5 by partition walls 4. An electrode plate member (not shown) in which positive electrode plates and negative electrode plates are alternatively laminated with separators in between is received in each cell chamber 5. Electrode plate members for the respective cell chambers 5 are connected in series through the partition walls 4.

A cover 2 is welded to the battery case 1 to close an upper opening of the battery case 1. Partition walls 6, corresponding respectively to the partition walls 4 of the battery case 1, are formed on a reverse surface of the cover 2, and these partition walls 6 are respectively welded to the partition walls 4 of the battery case 1, so that the upper side of each cell chamber 5 is covered with the cover 2. Reference numeral 3 denotes a lid.

Inlets 7 (described later in detail) and also exhaust chambers 8 respectively corresponding to the cell chambers 5 are formed in the cover 2. As shown in FIG. 2, each exhaust chamber 8 includes: an introduction port 9 which communicates with the corresponding cell chamber 5 so as to introduce gas, produced in the storage battery, into the exhaust chamber 8; an exhaust port 10 for exhausting the gas from the exhaust chamber 8; and a feed-back port 11 for returning an electrolyte entering the exhaust chamber 8. A bottom surface (bottom wall) 12 of the exhaust chamber 8 is slanting toward the feed-back port 11.

Many splash-proof plates 13 are formed within each exhaust chamber 8. FIG. 3 shows the cover 2 in a condition that the lid 3 is removed. As shown in this figure, the splash-proof plates 13 project alternately from opposed side walls 8b of the exhaust chamber 8, and a gap 14 is formed between a distal end of each splash-proof plate 13 and one of side walls 8b. The splash-proof plates 13 are slanting toward the feed-back port 11, and the distal end portion of each splash-proof plate 13 is bent toward the feedback port 11 to form a L-shaped bent portion 15.

A side wall 8a of each exhaust chamber 8, having the introduction port 9 and the feedback port 11 formed therein, is disposed adjacent to the inlet 7, and this side wall 8a is also slanting.

An exhaust passage 16 is in communication with the exhaust chambers 8, and is suitably divided into sections by partition walls 17, and these sections communicate with one another through recesses 18 formed respectively in upper edges of the partition walls 17.

Reference numeral 19 denotes a filter chamber in which an explosion-proof filter 20 is provided. Reference numeral 21 denotes an exhaust nozzle which is open at one end thereof to the filter chamber 19, and is open at the other end thereof to a side surface of the storage battery.

Reference numeral 22 denotes a bushing terminal of the storage battery which is molded in the cover 2, and a terminal post, connected to the electrode plate member, extend through a hollow portion of the bushing terminal 22. The bushing terminal 22 and the terminal post are welded together at their upper ends. Reference numeral 23 denotes a mounting hole for an indicator for monitoring a liquid level of the electrolyte and the specific gravity of the electrolyte.

Each of the battery case 1, the cover 2 and the lid 3 is molded of polypropylene. A paste of an active material, formed by kneading lead power with dilute sulfuric acid, is filled in each of grid plates (made of a lead alloy) to provide an electrode plate, and these electrode plates are used as positive and negative electrode plates. Laminates, each comprising acid-resistant perforated plates of a polymer and glass mats, are used as the separators, respectively. The positive and negative electrode plates and the separators are alternately laminate to provide the electrode plate member. These electrode plate member is received in each cell chambers 5. The electrode plate members, provided respectively in any two adjacent cell chambers 5, are connected, through the partition walls 6, in series by resistance welding via cell-interconnecting members. Terminal posts extended from the electrode plate members provided in the cell chambers located at both ends are inserted into bushing terminals 22.

The electrolyte, composed of dilute sulfuric acid, is poured into each of the cell chambers 5 via the inlet 7, and subjected to chemical conversion. Then, the upper lid 3 is fused to the cover 2 to cover the exhaust chambers 8. The indicator entirely made of a transparent synthetic resin, which is provided with two synthetic resin balls different in color and specific gravity, is threaded into the mounting hole 23, thereby completing the lead storage battery.

In this lead storage battery, even when the electrolyte intrudes into any exhaust chamber 8 by gas (produced by the charging of the battery) or vibrations during use, such intruded electrolyte is rapidly discharged from the exhaust chamber 8 without residing therein, and is returned to the cell chamber 5 via the feed-back port 11. This is because both of the bottom surface 12 of the exhaust chamber 8 and the splash-proof plates 13 are slanted toward the feed-back port 11.

Therefore, the problems, such as the intrusion of such residing liquid into the adjacent cell chamber 5 and the leakage of this liquid to the exterior, can be avoided.

The produced gas is separated from the liquid by the splash-proof plates 13, and is fed to the exhaust passage 16 via the exhaust port 10 of the exhaust chamber 8, and is further fed to the filter chambers 19 through the recesses 18 formed in the respective partition plates 17, and is dispersed by the explosion-proof filters 20, and is safely vented to the exterior from the exhaust nozzle 21.

In the above embodiment, although the introduction port 9 is formed in the upper portion of the exhaust chamber 8 while the feed-back port 11 is formed in the lower portion of the exhaust chamber 8, the provision of the introduction port 9 may be omitted, in which case the feed-back port 11 serves also as such an introduction port.

FIG. 4 shows a second embodiment of the invention. Elements similar to those in the first embodiment are designated by the same reference numerals, and repetitive explanations for those will be omitted.

In this embodiment, in the cover 2, the respective exhaust chambers 8 and the respective exhaust passages 16 are isolated by the partition walls 6, 8b and 17 without being communicated with each other. Each of the exhaust chambers 8 is extended from the associated inlet 7 to the associated exhaust passage 16 in the longitudinal direction of the associated cell chamber 5 (i.e., the direction perpendicular to that in the first emb diment).

Although it is not shown explicitly in the figure, members corresponding to the recesses 18 in the first embodiment are provided on portions in a lower face of the lid 3 that oppose to the partition walls 17. Every adjacent exhaust passages 16 are communicated therethrough. The gas produced in the cell chamber 5 is separated from the liquid by the splash-proof plates 13, and is fed to the exhaust passage 16 via the exhaust port 10 of the exhaust chamber 8, and is further fed to the filter chambers 19 through the communicating ports formed in the lid 3, and is dispersed by the explosion-proof filters 20, and is safely vented to the exterior from the exhaust nozzle 21.

The configuration in this embodiment is suitable for the airtightness test. In the test, it is inspected whether each of the cell chambers 5 is airtightly sealed after the manufacturing of the storage battery. Specifically, the inlet 7 of one in every two adjacent exhaust chambers 8 is sealed and then a predetermined pressure is applied to the cell chamber 5 of interest. It is confirmed that the pressure is unchanged after a predetermined time period elapses. Pressure variation means that the leak of the electrolyte in the cell chamber 5. In this embodiment, the above airtightness test can be easily performed by abutting a rubber member of a test head against portions painted with black in FIG. 5. Accordingly, it is preferable that top faces of the partition walls 17 of the exhaust passages 16 are made flat uniformly as well as top faces of the side walls 8b and the partition walls 6 of the exhaust chambers 8.

What is claimed is:

1. An exhaust structure provided on an upper part of a storage battery, comprising:
an exhaust chamber, formed with:
an inlet, through which gas generated from a cell chamber of the storage battery is introduced;
a first outlet, arranged in an upper portion of the exhaust chamber and through which the gas is exhausted to an exterior of the storage battery;
a second outlet, arranged in a bottom portion of the exhaust chamber and communicated with the cell chamber; and
side walls and a bottom wall defining the exhaust chamber, the bottom wall being slanted toward the second outlet; and
a plurality of plate members, which intercepts liquid contained in the gas, each of the plate members being extended from one of the side walls such that a distal end portion faces another one of the side walls while defining a gap therebetween, and being slanted toward the second outlet so that the intercepted liquid is guided to the second outlet and returned to the cell chamber.

2. The exhaust structure as set forth in claim 1, wherein the distal end portion of each of the plate members is bent so as to be directed toward the second outlet.

3. The exhaust structure as set forth in claim 1, wherein at least one of the side walls is slanted toward the second outlet.

4. The exhaust structure as set forth in claim 1, wherein one of the side walls is formed with the first outlet, and top faces of the other side walls are made flat uniformly.
